(19) United States
(12) Patent Application Publication
(10) Pub. No.: US 2009/0314809 A1
(43) Pub. Date: Dec. 24, 2009

(54) Ejection device

(75) Inventors: Hans Peter Lederle, Durach (DE); Rainer Stobel-Schmidt, Bad Woerishofen (DE); Peter Ostermeier, Diessen (DE); Christian Hefele, Breitenbrunn (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 12/456,545

(22) Filed: Jun. 17, 2009

(30) Foreign Application Priority Data
Jun. 19, 2008 (DE) 10 2008 002 523.2

(51) Int. Cl. B67D 5/42; B67D 5/52

(52) U.S. Cl. 222/392; 222/137

(57) ABSTRACT

An ejection device (11) for compound-containing containers (6) has a receptacle (12) for the container (6) and two piston rods (21) having a pressure transmitting element (23) at its end (22) facing the receptacle (12). The ejection device (11) also has a displacement unit (31) for displacing the piston rods (21) in direction of the receptacle (12) and includes a drive (41) and a displacement device (51) having a retraction element (52), and the drive (41) having a drum unit (61) with a rotating member (62) for the retraction element (52). The retraction element (52), is secured, on one hand, in a region of an end (24) of the piston rods (21) remote of the receptacle (12) and, on the other hand, is wound onto the rotating member (62) of the drum unit (61).

### BACKGROUND OF THE INVENTION

1. Field of the Invention

The invention is directed to an ejection device for compound-containing containers and including a receptacle for the container, at least one piston rod provided with pressure transmitting means at its end facing the receptacle, and a displacement unit for displacing the at least one piston rod in direction of the receptacle and having a drive and a displacement device.

2. Description of the Prior Art

An ejection device of the type mentioned above is used for dispensing compounds such as mortar compounds or sealing compounds, which are packaged in containers, e.g., foil bags or cartridges, at an application site. Upon actuation of the displacement unit, the at least one piston rod is advanced by a certain amount so that the pressure transmitting means provided at the piston rod end acts on the container and dispenses a corresponding amount of the compound contained therein through an outlet opening in the head part. At the conclusion of the ejection process or for changing the container, the at least one piston rod must be returned to its initial position in which the previously inserted container can be removed from the receptacle and a new container can be inserted into the receptacle.

British Publication GB 2 224 782 discloses an ejection device for compound-containing containers which has a receptacle for the container and a piston rod for squeezing out the compound from the container. This piston rod has, as pressure transmitting means, a piston provided at its end facing the receptacle. Further, a displacement unit is provided for displacing the piston rod in direction of the receptacle. The displacement unit has a handle with a pivotable actuation lever that serves as a drive. With each actuation, the pivotable actuation lever pivots a plate member through which the piston rod extends and which serves as a displacement element for the piston rod. The pivoting movement of the plate member is transmitted to the piston rod by frictional engagement so that the piston rod is displaced by a corresponding amount. To retract the piston rod, the plate member contacting the piston rod is disconnected from the piston rod by a release device, and the piston rod is retracted manually.

Ejection devices of the kind mentioned above have successfully proven themselves. The drawback of the known solution consists in that the plate member is exposed to severe wear in the area of contact with the piston rod.

German Publication DE 298 12 284 U1 discloses an ejection device of the generic type having a toothed wheel as a displacement unit which is driven by a motor serving as a drive. The toothed wheel meshes with a toothing provided on the piston rod. In order to retract the piston rod, the piston rod is disconnected from the toothed wheel, for example, by rotation and is retracted manually, or the piston rod is retracted back by reversing the rotation of the motor.

The drawback of the known solution consists in that the manufacturing tolerances of the toothed wheel and of piston rod toothing must be small for properly advancing the piston rod and, therefore, it is expensive to manufacture an ejection device of this kind. A further drawback consists in that the retraction of the piston rod back by the motor is time-consuming.

German Publication DE 37 04 210 A1 discloses an ejection device for a compound-containing container having a receptacle for the container and a spring-loaded piston as pressure transmitting means. When a pivotable actuation lever of a handle is actuated, a braking device is released which permits a displacement of the piston in direction of the receptacle for ejecting the compound from the container. At the conclusion of the ejection process, the piston is retracted against spring force by a winding-up device. This ejection device has no piston rod projecting from the displacement unit and is distinguished in particular by its short constructional length.

The drawback of the device disclosed in DE 37 04 210 A1 consists in that the individual amounts of the dispensed compound vary widely during the ejection process because an accurate metering is impossible with this ejection device. Further, the usability of the ejection device is limited, for example, due to relaxation of the spring element which biases the piston.

### SUMMARY OF THE INVENTION

It is the object of the invention to provide an ejection device which is constructed in a simple manner and which ensures an accurate metering of a to-be-dispensed compound.

This and other objects of the present invention, which will become apparent hereinafter, are achieved by providing, according to the invention, an ejection device the displacement device of which has at least one retraction element, and the drive has a drum unit with a rotating member for the retraction element. The retraction element is secured, on one hand, in a region of the end of the at least one piston rod remote of the receptacle and, on the other hand, can be wound onto the rotating member of the drum unit.

By actuating the drive which acts directly or indirectly on the rotating member of the drum unit and sets the latter in rotation, the distance between the drum unit and the point at which the retraction element is fastened to the at least one piston rod, is gradually decreased. The at least one piston rod and, therefore, the pressure transmitting means provided thereat are displaced in direction of the receptacle and, in so doing, a defined amount of a compound is dispensed from the container inserted into the receptacle. The retraction element takes on the resulting retraction forces and transmits them to the at least one piston rod as pressure forces. The retraction element is fastened to the at least one piston rod, for example, directly or with a holding element, e.g., a yoke. Since the transmission of force to the piston rod is carried out by positive engagement, there is no slippage in the ejection device and high forces can be transmitted during the displacement, which is a substantial advantage particularly when dispensing viscous compounds.

No significant wear occurs at the at least one piston rod caused by displacement, which substantially prolongs the useful life of the entire ejection device. Further, the ejection device has only a few individual constructional components, and these components are available as mass-produced parts which can easily be exchanged individually if need be. Depending on the type of drive, the displacement of the at least one piston rod can be carried out in a discontinuous or continuous manner.

In a multi-component system in which, for example, different components of a multi-component compound are dispensed simultaneously, the ejection device advantageously has at least two piston rods which can advantageously be displaced simultaneously in direction of the receptacle with only one retraction element. The retraction element is advantageously arranged at the center of gravity of the forces acting on the piston rods so that frictional loss between the elements of the ejection device is reduced to a minimum.

The retraction element is preferably a flexible belt so that the retraction element has an advantageous inherent rigidity. In an alternative embodiment of the invention, the retraction element is formed by a rope. These types of retraction elements can be wound up on the rotating member of the drum unit in a simple manner and can therefore be stowed compactly in the housing. The retraction element has a certain inherent tension which is relaxed in the rolled-up position and therefore acts like a torsion spring so that the retraction element automatically maintains tension and, therefore, does not sag between the displacement unit and the point at which it is fastened to the at least one piston rod. The retraction element is advantageously formed of a corrosion-resistant material.

The displacement device preferably has a displacement claw with a force transmission surface which can be brought into contact with the rotating member for transmitting a displacement generated by the drive. The transmission of the displacement force from the displacement claw to the rotating member can be carried out by means of frictional engagement and positive engagement. The displacement claw is connected, for example, to a lever mechanism which is in turn connected to the drive. When the drive is actuated, the rotating member of the drum unit rotates by a certain amount so that a corresponding length of the retraction element is wound up onto the rotating member. As a result, the at least one piston rod is advanced by a certain amount so that a corresponding amount of the compound is dispensed from the container.

The displacement device preferably has a holding claw with a contact surface which can be brought into contact with the rotating member for holding the rotating member in a position. The transmission of the holding force from the holding claw to the rotating member can be carried out by frictional engagement and/or by positive engagement. The holding claw holds the rotating member of the drum unit in a position attained previously by rotation and prevents undesirable displacement of the rotating member opposite to its wind-up direction, particularly in case of a discontinuous drive. Depending on the construction of the drum unit and drive, a displacement claw may be omitted so that, for example, only a holding claw is provided at the drum unit.

A toothing is preferably provided on the force transmission surface of the displacement claw and/or on the contact surface of the holding claw and engages the toothing provided on the radial outer side at the rotating member of the drum unit. The teeth of the displacement claw and/or of the holding claw are advantageously constructed so as to complement the toothing at the rotating member, which enables a transmission of force from the displacement claw and/or the holding claw by positive engagement.

The force transmission surface of the displacement claw preferably has a longitudinal extension over an angular area of 10° to 90° with respect to the circumference of the rotating member of the drum unit so that an advantageous length is available for transmitting the displacement forces. When the displacement claw has teeth, a sufficient number of teeth can be provided for a sufficient transmission of force to the rotating member by a longitudinal extension over an angular area of 10°. The force transmission surface of the displacement claw advantageously has a longitudinal extension over an angular area of 40° to 75° with respect to the circumference of the rotating member of the drum unit.

The contact surface of the holding claw preferably has a longitudinal extension over an angular area of 10° to 90° with respect to the circumference of the rotating member of the drum unit so that an advantageous length is available for transmitting the holding forces. When the holding claw is provided with teeth, a sufficient number of teeth can be provided for a sufficient transmission of force to the rotating member by a longitudinal extension over an angular area of 10°. The contact surface of the holding claw advantageously has a longitudinal extension over an angular area of 40° to 75° with respect to the circumference of the rotating member of the drum unit.

The displacement claw and/or the holding claw are/is preferably pretensioned in direction of the drum unit. This ensures a contact of the displacement claw and/or holding claw in all possible orientations of the ejection device with respect to a constructional component. Further, the transmission of force from the displacement claw and/or holding claw to or from the rotating member of the drum unit is accordingly ensured.

A release device is preferably provided for releasing the drum unit. By relaxing the drum unit, this release device makes it possible for the at least one piston rod to be moved into a retracted position in which a squeezed out container can be removed from the receptacle and a new container inserted into the receptacle. The at least one piston rod is advantageously moved into the retracted position manually after actuating the release device.

In the release position of the release device, the displacement claw and/or the holding claw are/is advantageously disengaged from the rotating member of the drum unit. In particular, when the displacement claw and/or the holding claw transmit(s) the forces to the rotating member by means of a toothing, the meshing between the claws and the drum unit is canceled by actuating the release device so that the at least one piston rod can easily be moved into a retracted position.

A protruding cam is preferably provided on the displacement claw and/or on the holding claw, respectively, and can be brought into contact with a correspondingly shaped control cam of the release device to guide the displacement claw and/or the holding claw when the release device is actuated. When the release device is actuated, the displacement claw and/or the holding claw are/is disengaged from the rotating member such that the timing of the disengaged state can be controlled by the shape of the control cams along which the cams slide. This construction ensures a simple uncoupling and coupling of the displacement claw and/or holding claw from and to the rotating member of the drum unit.

The release device preferably has a resetting element for moving the release device into a position in which the displacement claw and/or the holding claw are/is in contact with the rotating member of the drum unit. The resetting element is advantageously a spring element and, particularly advantageously, a torsion spring. The resetting element ensures a simple coupling of the displacement claw and/or the holding claw with the rotating member of the drum unit when the release device is actuated in a corresponding manner.

The drive preferably includes a manually actuated actuation lever for rotating the rotating member of the drum unit, the actuation lever acting directly or indirectly on the rotating member of the drum unit via a lever mechanism.

In an alternative embodiment of the invention, the drive includes a motor for rotating the rotating member of the drum unit, which makes it possible to control the driving of the rotating member in a simple manner. A transmission is advantageously provided between the motor, which is operated, e.g., by line voltage or battery, for transmitting the rotational motion generated by the motor to the rotating member of the drum unit and for changing speeds. The rotating member can be driven in a discontinuous or continuous manner by the motor. Since the motor holds the rotating member of the drum unit in a predetermined position, additional securing means, e.g., a holding claw for holding the rotating member of the drum unit, can be dispensed with.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS:

The drawings show:

FIG. 1 a longitudinal side view of an ejection device according to the present invention;

FIG. 2 a top view of the ejection device shown in FIG. 1;

FIG. 3 a side view of the drum unit in the displacement position;

FIG. 4 a side view of the drum unit in the release position;

FIG. 5 a side view of the release device of the drum unit; and

FIG. 6 a longitudinal side view of the second embodiment of an ejection device according to the present invention.

Generally, identical parts are provided with identical reference numerals in the drawings.

### DETAILED DESCRIPTION OF THE PREFERRED EMBODIMENTS

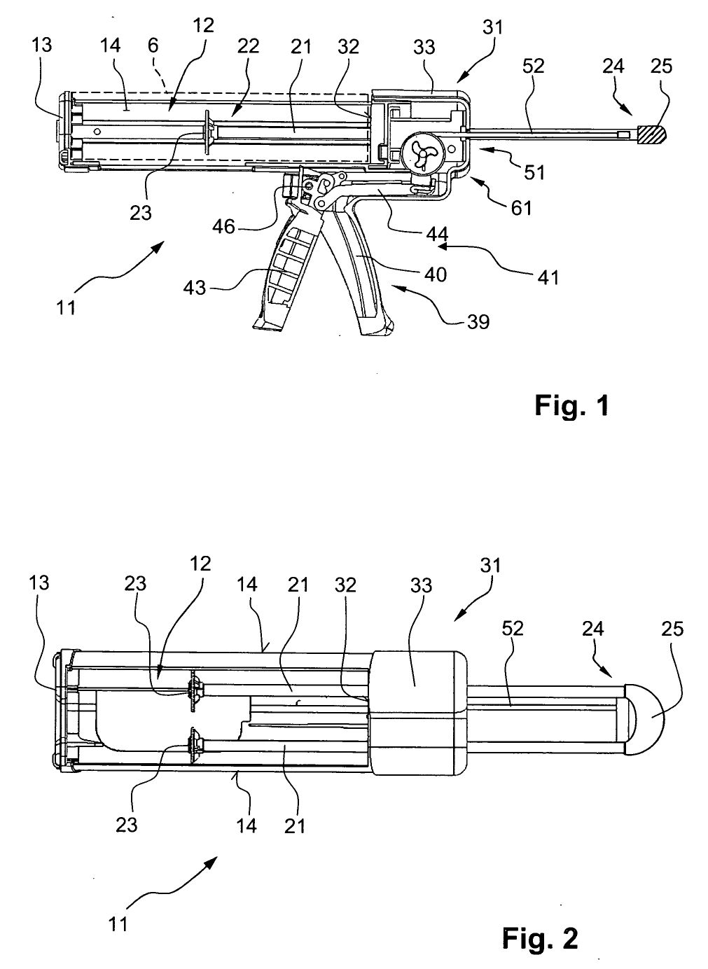

An ejection device 11 for compound- containing containers 6 and which is shown in FIGS. 1 and 2, has a receptacle 12 for the container 6. The receptacle 12 is defined axially by a head plate 13 and a rear boundary wall 32 as part of a housing 33 of a displacement unit 31 and laterally by side walls 14. Further, the ejection device 11 has two piston rods 21 which are oriented parallel to one another and have a piston as pressure transmitting means 23 at their ends 22 facing the receptacle 12 and are connected to one another by a yoke 25 at their opposite ends 24. The displacement unit 31, which adjoins the receptacle 12 and serves to displace the piston rods 21 in direction of the receptacle 12, includes a drive 41 and a displacement device 51. The displacement device 51 has a flexible belt with a certain degree of flexibility and which serves as a retraction element 52. The drive 41 includes a drum unit 61 with a rotating member 62 for the retraction element 52. The retraction element 52 is secured, in a region of the end 24 of the piston rods 21 which is remote from the receptacle, to a cross strut 26 which connects the two piston rods 21 and can be wound onto the rotating member 62 of the drum unit 61. In an alternative embodiment, not shown, the retraction element 52 can also be secured directly to the yoke 25 or only to one of the piston rods 21.

The drive 41 is provided with a stationary grip 40 at a handle 39 projecting from the displacement unit 21 and includes an actuation lever 43 which can be actuated manually and which is pivotally secured at a bearing point 46.

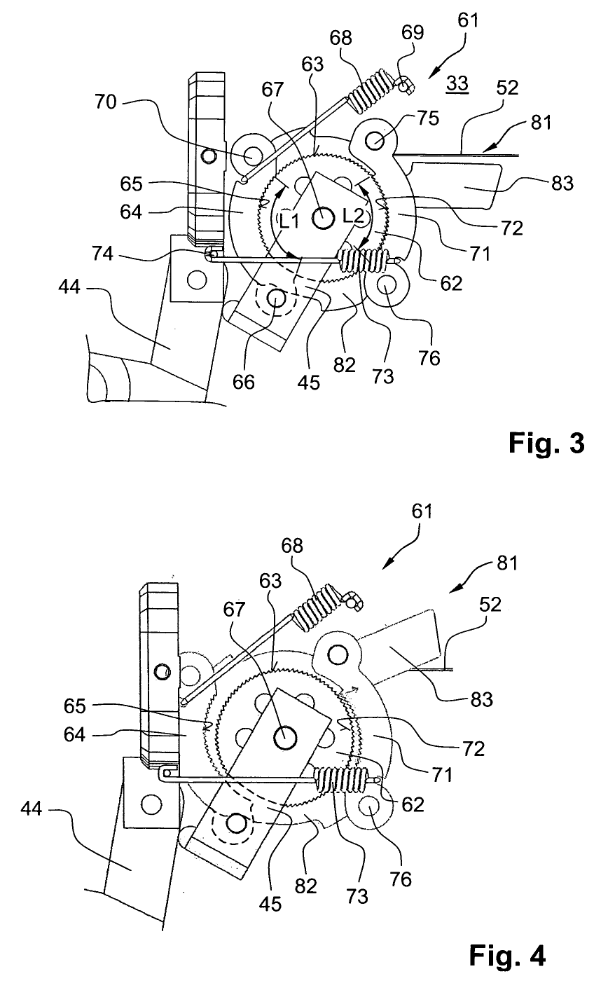

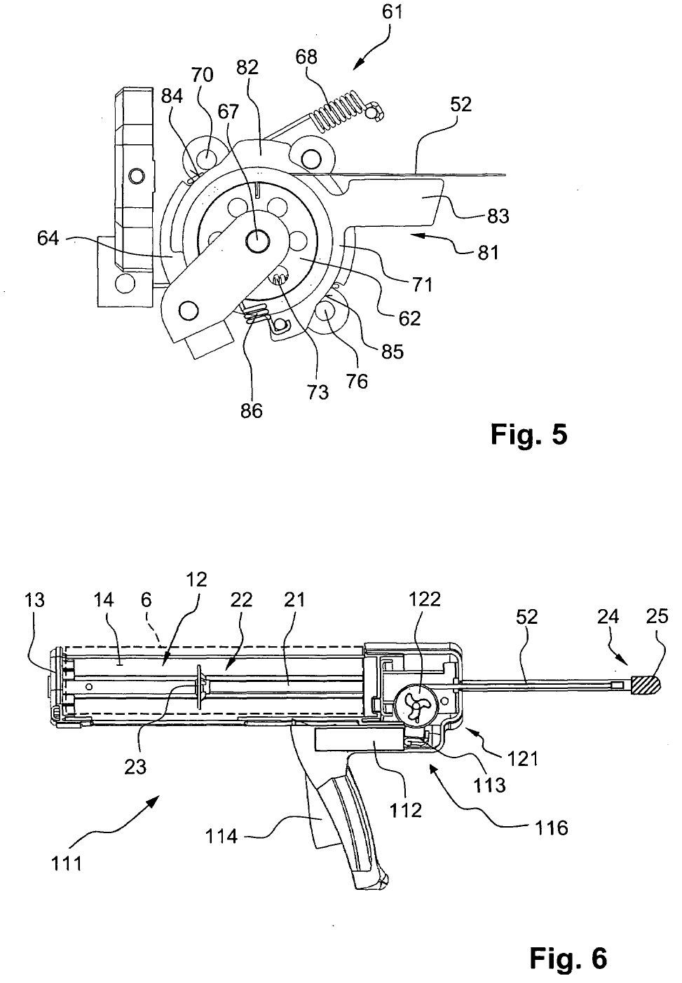

The drum unit 61 is shown in detail in FIGS. 3 to 5 in different positions. A radial circumferential toothing 63 is provided on the outer side of the cylindrical rotating member 62 of the drum unit 61. Further, the displacement device 51 has a displacement claw 64 with a force transmission surface which can be brought into contact with the rotating member 62 for transmitting displacement produced by the drive 41, and a holding claw 71 with a contact surface which can be brought into contact with the rotating member 62 for holding the rotating member 62 in position. A toothing 65 provided at the force transmission surface of the displacement claw 64 and a toothing 72 provided at the contact surface of the holding claw 71 are formed so as to complement the toothing 63 provided at the rotating member 62 and mesh therewith in the engaged state.

The force transmission surface of the displacement claw 64 has a longitudinal extension L1 over an angular area of 30° to 90°, advantageously over an angular area of 45° to 75°, with respect to the circumference of the rotating member 62 of the drum unit 61. The contact surface of the holding claw 71 has a longitudinal extension L2 over an angular area of 10° to 90°, advantageously over an angular area of 40° to 75°, with respect to the circumference of the rotating member 62 of the drum unit 61. Although the displacement claw 64 and the holding claw 71 should advantageously have substantially the same design, particularly with respect to their force transmission surface and contact surface, for example, to facilitate manufacture of the elements of the displacement device 51, the holding claw 71 and the displacement claw 64 can also have different longitudinal extensions.

The displacement claw 64 is secured at a bearing point 66 to a transmission lever 45 so as to be pivotable, the transmission lever 45 serving to transmit motion from the drive 41 to the rotating member 62 of the drum unit 61. Further, the displacement claw 64 is pretensioned in direction of the rotating member 62 by a spring 68 which is secured to the displacement claw 64, on one hand, in an end region of the displacement claw 64 remote from the bearing point 66 and, on the other hand, to a fixed holding point 69 at the housing 33 of the displacement unit 31.

The holding claw 71 is pivotally secured to the housing 33 of the displacement unit 31 at a bearing point 75. Further, the holding claw 71 is pretensioned in direction of the rotating member 62 by a spring 73 which is secured to the holding claw 71 on one hand in an end region of the holding claw 71 remote of the bearing point 75 and, on the other hand, to a stationary holding point 74 at the housing 33 of the displacement unit 31.

A release device 81 with a release lever 83 arranged at a release disk 82 is provided for releasing the drum unit 61. In a release position of the release device 81, the displacement claw 64 and the holding claw 71 are disengaged from the rotating member 62 of the drum unit 61. A cam 70 extending transverse to the longitudinal extension of the retraction element 52 is provided on the displacement claw 64 and can be brought into contact with and slide along a control cam 84 which is formed in a corresponding manner at the release disk 82 to guide the displacement claw 64 when the drum unit 61 is released. A cam 76 extending transverse to the longitudinal extension of the retraction element 52 is provided on the holding claw 71 and can be brought into contact with and slide along a control cam 85 which is formed in a corresponding manner at the release disk 82 to guide the holding claw 71 when the drum unit 61 is released.

When the actuation lever 43 is pivoted in direction of the handle 40, the rotating member 62 is set in rotation by a lever arrangement 44 and the transmission lever 45 which is supported in a pivotable manner at the bearing axis 67 of the rotating member 62 of the drum unit 61. Thereby, the displacement claw 64 which is connected to the transmission lever 45, is rotated in a counterclockwise direction. Because of the spring-mounting of the displacement claw 64, the toothing 65 meshes with the toothing 63 at the outer side of the rotating member 62 of the drum unit 61 which accordingly rotates counterclockwise around its bearing axis 67.

The retraction element 52, which is secured to the rotating member 62 of the drum unit 61, is wound onto the rotating member 62 of the drum unit 61 discontinuously, i.e., by a corresponding amount with each actuation of the actuation lever 43. The distance between the end 24 of the piston rods 21 remote of the receptacle 12 and the displacement unit 31 is reduced by the rotation of the rotating member 62, in this case, in the counterclockwise direction, and the piston rods 21 are displaced in direction of the receptacle 12 and a compound 6 located in the container 6 is ejected.

Since only a limited angular degree is available per actuation of the actuation lever 43, the actuation lever 43 must be reset before every new actuation. During this resetting phase, the retraction element 52, which is being pulled, must be held in position. This function is taken on by the holding claw 71 which blocks the rotating member 62 of the drum unit 61 opposite to the winding-up direction for the retraction element 52. When the rotating member 62 advances, the holding claw 71 slips—in the counterclockwise direction in this embodiment—and prevents unwanted rotation of the rotating member 62 in the clockwise direction at the conclusion of the rotational displacement movement. When the actuation lever 43 is reset, the drive 41 is again available for another ejection process.

When the retraction element 52 is completely wound up or if the container 6 inserted into the receptacle 12 is to be replaced by another container 6, the piston rods 21 must be moved into a retracted position and the retraction element 52 must be unwound from the rotating member 62 of the drum unit 61 again. For this purpose, the release disk 82 of the release device 81 is pivoted in clockwise direction by about 10° to 30° so that the cam 70 of the displacement claw 64 comes into contact with the control cam 84 and the cam 76 of the holding claw 71 comes into contact with control cam 85 so that the displacement claw 64 and holding claw 71 are lifted from the rotating member 62 of the drum unit 61 and their teeth 65 and 72, respectively, disengage from the teeth 63 at the outer side at the rotating member 62. Accordingly, the drum unit 61 is freely movable, and the piston rods 21 can be moved into a retracted position.

A spring element, e.g., a torsion spring, can be provided as a resetting element 86 at the release disk 82 of the release device 81, which ensures a simple resetting of the release device 81 so that the toothing 65 of the displacement claw 64 and the toothing 72 of the holding claw 71 reenter in a positive engagement with the toothing 63 at the rotating member 62 of the drum unit 61. The displacement claw 64 and the holding claw 71 are moved respectively by the spring 68 and 73 acting upon them, respectively, into a position in which they are held in engagement with the toothing 63 at the outer side of the rotating member 62 of the drum unit 61. Considering the construction of the springs 68 and 73, a separate resetting element 86 is not required for properly restoring the release disk 82 of the release device 81 to a starting position in which the displacement claw 64 and the holding claw 71 contact the rotating member 62 of the drum unit 61. This is because the release disk 82 is moved by the spring forces acting on the displacement claw 64 and the holding claw 71 into its starting position by the cams 70 and 76.

In contrast to the ejection device 11 described above, the ejection device 111 which is shown in FIG. 6, has a motor 112 which serves as a drive 116 and which advantageously sets the rotating member 122 of the drum unit 121 in rotation via transmission 113 when a push switch 114 is actuated for winding up the retraction element 52. Since the motor 112 acts directly on the rotating member 122 by means of the transmission 113 and prevents a rotation of the rotating member 122 when stopped, there is no need for a displacement claw 64 or a holding claw 71 as in the displacement device 51 described above.

Further, the wound up retraction element 52 can be unwound again by motor by reversing the rotation of the motor 112, or the drum unit 121 can be released for retracting the piston rods 21 by disengaging the transmission 113 or motor 112 from the drum unit 121.

Though the present invention was shown and described with references to the preferred embodiments, such are merely illustrative of the present invention and are not to be construed as a limitation thereof, and various modifications of the present invention will be apparent to those skilled in the art. It is therefore not intended that the present invention be limited to the disclosed embodiments or details thereof, and the present invention includes all variations and/or alternative embodiments within the spirit and scope of the present invention as defined by the appended claims.

What is claimed is:

1. An ejection device for compound-containing containers (6), comprising a receptacle (12) for a container (6); at least one piston rod (21) having pressure transmitting means (23) at an end (22) thereof facing the receptacle (12); a displacement unit (31) for displacing the at least one piston rod (21) in direction of the receptacle (12) and including a drive (41; 116), and a displacement device (51), wherein the displacement device (51) has at least one retraction element (52), and the drive (41; 116) has a drum unit (61; 121) with a rotating member (62; 122) for the at least one retraction element (52), the retraction element (52), on one hand, being secured in a region of an end (24) of the at least one piston rod (21) remote from the receptacle (12) and, on the other hand, being wound up onto the rotating member (62; 122) of the drum unit (61; 121).

2. An ejection device according to claim 1, wherein the retraction element (52) is a pliable belt.

3. An ejection device according to claim 1, wherein the displacement device (51) has a displacement claw (64) with a force transmission surface which can be brought into contact with the rotating member (62) for transmitting a displacement generated by the drive (41).

4. An ejection device according to claim 1, wherein the displacement device (51) has a holding claw (71) with a contact surface which can be brought into contact with the rotating member (62) for holding the rotating member (62) in a position.

5. An ejection device according to claim 4, wherein a toothing (65) is provided on at least one of the force transmission surface of the displacement claw (64) and the contact surface of the holding claw (71) and engages in a toothing (63) provided on a radial outer side at the rotating member (62) of the drum unit (61).

6. An ejection device according to claim 3, wherein the force transmission surface of the displacement claw (64) has a longitudinal extension (L1) over an angular area of 10° to 90° with respect to the circumference of the rotating member (62) of the drum unit (61).

7. An ejection device according to claim 4, wherein the contact surface of the holding claw (71) has a longitudinal extension (L2) over an angular area of 10° to 90° with respect to the circumference of the rotating member (62) of the drum unit (61).

8. An ejection device according to claim 4, wherein at least one of the displacement claw (64) and the holding claw (71) is pretensioned in direction of the rotating member (62) of the drum unit (61).

9. An ejection device according to claim 1, comprising a release device (81) for releasing the drum unit (61).

10. An ejection device according to claim 8, wherein in a release position of the release device (81), at least one of the displacement claw (64) and the holding claw (71) is disengaged from the rotating member (62) of the drum unit (61).

11. An ejection device according to claim 10, wherein a protruding cam (70 and 76) is provided on the at least one of the displacement claw (64) and at the holding claw (71), and can be brought into contact with a correspondingly shaped control cam (84 and 85) of the release device (81) to guide the at least one of the displacement claw (64) and the holding claw (71) when the release device (81) is actuated.

12. An ejection device according to claim 10, wherein the release device (81) has a resetting element (86) for moving the release device (81) into a position in which the at least one of the displacement claw (64) and the holding claw (71) are in contact with the rotating member (62) of the drum unit (61).

13. An ejection device according to claim 1, wherein the drive (41) includes a manually actuated actuation lever (43) for rotating the rotating member (62) of the drum unit (61).

14. An ejection device according to claim 1, wherein the drive (116) includes a motor (112) for rotating the rotating member (122) of the drum unit (121).
